(19) United States
(12) Patent Application Publication
(10) Pub. No.: US 2026/0054794 A1
(43) Pub. Date: Feb. 26, 2026

(54) Method for calibrating an inclination sensor for a two-wheeled vehicle

(71) Applicant: SCHAEFFLER TECHNOLOGIES AG & CO. KG, Herzogenaurach (DE)

(72) Inventor: Jean-Luc FREMAUX, Toulouse (FR)

(73) Assignee: SCHAEFFLER TECHNOLOGIES AG & CO. KG, Herzogenaurach (DE)

(21) Appl. No.: 19/283,438

(22) Filed: Jul. 29, 2025

(30) Foreign Application Priority Data
Aug. 21, 2024 (FR) 2409012

(51) Int. Cl. B62J 45/415; G01C 25/00

(52) U.S. Cl. CPC B62J 45/4151; G01C 25/005

(57) ABSTRACT

A method for calibrating an inclination sensor for a two-wheeled vehicle, including: selecting a two-wheeled vehicle including the inclination sensor to be calibrated; inclining the vehicle at a first determined lateral inclination angle; recording the value of the projection of the earth's gravity over the three axes; inclining the vehicle at a second predetermined lateral inclination angle; recording the value of the projection of the earth's gravity over the three axes; computing a projection matrix between the intrinsic reference frame of the inclination sensor and the reference frame specific to the vehicle based on the projection of the earth's gravity over the three axes of the intrinsic reference frame and the reference frame of the vehicle; and recording the projection matrix computed for each vehicle.

### CROSS REFERENCE TO RELATED APPLICATIONS

This application claims priority to French Application No. FR2409012, filed Aug. 21, 2024, the contents of such application being incorporated by reference herein.

### FIELD OF THE INVENTION

The present invention relates to the field of motorized two-wheeled vehicles and more specifically relates to measuring the lateral inclination of the vehicle.

### BACKGROUND OF THE INVENTION

In order to improve driver safety, many motorized two-wheeled vehicles are currently equipped with systems that can directly act on the operation of the vehicle, without the intervention of the driver, as soon as a critical situation is detected.

As is well known, motorized two-wheeled vehicle manufacturers include inclination sensors in these vehicles that notably measure the lateral inclination of the two-wheeled vehicle. These sensors are configured to have a maximum inclination threshold, above which the vehicle is considered to be falling, triggering the engine to stop and thus ensuring the safety of the driver.

For example, if this threshold is 60° relative to a vertical direction defined by the earth's gravity, and the effective inclination angle of the two-wheeled vehicle is beyond 60°, the vehicle is considered to be falling and the engine is stopped.

This device also prevents the engine from starting if the vehicle is inclined beyond this threshold when the user starts it up.

A first generation of inclination sensors is mechanical and these inclination sensors are attached to the vehicle chassis. These sensors contain weights (for example, balls) that move according to the inclination of the vehicle and close electrical contacts when a given inclination is reached. The inertia of these weights then determines the sensitivity of the sensor to the incline of the vehicle and, in addition, the precision of the angle measurement.

However, these sensors are bulky and involve significant constraints in terms of attachment on the vehicle chassis. For these reasons, a new generation of sensors is used, made up of an electronic control unit that contains a MEMS (Micro Electro Mechanical System) type accelerometer.

This sensor can be placed anywhere in the vehicle depending on its design. However, this freedom requires the sensor to be calibrated so that, once installed, the position and the orientation of the sensor are known relative to a reference frame, enabling the sensor to measure the correct value for the inclination angle of the vehicle.

If the sensor is incorrectly calibrated, its position and orientation relative to the reference frame of the vehicle are not correctly taken into account by the electronic control unit. The inclination sensor then generates incorrect inclination measurements, thus risking triggering the engine shut-off function even if the inclination of the vehicle is below the maximum acceptable threshold.

One solution to this problem is to calibrate the sensor when it is installed on a vehicle in the factory when producing a series of the same model of vehicles. This ensures that the inclination of the vehicle is measured correctly, but this calibration must be carried out individually for each vehicle, which takes a considerable amount of time during production.

Therefore, a requirement exists for a simple and effective solution for at least partly overcoming these disadvantages.

### SUMMARY OF THE INVENTION

To this end, an aspect of the invention firstly relates to a method for calibrating an inclination sensor intended to be mounted on a motorized two-wheeled vehicle, said vehicle comprising an electronic control unit, said electronic control unit comprising said inclination sensor and a memory zone, said inclination sensor being configured to determine the projection of the earth's gravity over three axes of an intrinsic reference frame of the inclination sensor, the electronic control unit being configured to compute the inclination angle based on the projection of the earth's gravity over the three axes of a reference frame specific to the vehicle, said method being partially implemented by a calibration device connected to the vehicle, and comprising the steps of:
selecting at least one two-wheeled vehicle comprising said inclination sensor to be calibrated;
inclining the at least one selected vehicle at a first determined lateral inclination angle;
recording, by the calibration device, the value of the projection of the earth's gravity over the three axes of the intrinsic reference frame of the inclination sensor when the at least one vehicle is inclined at the first lateral inclination angle;
inclining the at least one selected vehicle at a second predetermined lateral inclination angle;
recording, by the calibration device, the value of the projection of the earth's gravity over the three axes of the intrinsic reference frame of the inclination sensor when the at least one vehicle is inclined at the second lateral inclination angle;
computing, by the calibration device, a projection matrix between the intrinsic reference frame of the inclination sensor and the reference frame specific to the vehicle based on the projection of the earth's gravity over the three axes of the intrinsic reference frame and the reference frame of the vehicle;
recording the computed projection matrix in the memory zone of the electronic control unit for each vehicle corresponding to the type of vehicle comprising said electronic control unit.

This method allows the electronic control unit to be calibrated quickly and efficiently for computing the lateral inclination angle based on the measurements by the inclination sensor. The method allows the reference frame of the vehicle to be defined by computing three unit vectors perpendicular to each other based on the vector of the earth's gravity measured in each of the two inclinations of the vehicle in the reference frame of the inclination sensor. The 3×3 projection matrix, whose columns correspond to the three vectors thus computed, allows the intrinsic reference frame of the inclination sensor to transition to this reference frame of the vehicle, one axis of which is parallel to the longitudinal direction of the vehicle.

Once the projection matrix has been determined, it can be recorded in the memory zone of each electronic control unit mounted on a vehicle corresponding to the selected vehicle, allowing immediate calibration of these vehicles and avoiding individual calibration of each of them, which would be time-consuming and costly.

Advantageously, the step of computing the projection matrix between the intrinsic reference frame of the inclination sensor and the reference frame specific to the vehicle is carried out by computing the vector product between the vector of the earth's gravity in the first inclination and the vector of the earth's gravity in the second inclination, by normalizing the vector of the earth's gravity in the first inclination, by normalizing the vector computed by the vector product, and by computing a third vector based on the vector product of the two normalized vectors and by computing the projection matrix whose columns are the three vectors thus normalized. Thus, the method allows the specific reference frame of the vehicle to be computed and at the same time allows the projection matrix to be defined between the intrinsic reference frame of the inclination sensor and this specific reference frame.

Preferably, the difference between the first inclination angle and the second inclination angle is greater than 15 degrees. In this way, the angle between the two measured vectors of the earth's gravity is large enough to avoid approximation errors when computing the vector product between these two vectors.

In a preferred embodiment, the method comprises a preliminary step of checking physical parameters required for the calibration. This step is important to ensure that external parameters do not distort the calibration and the measurement of the inclination angle of vehicles under normal operating conditions.

In this embodiment, it is advantageous for the preliminary step of checking physical parameters to include measuring the inclination of the ground. For example, this step can involve comparing the measurement of the inclination of the ground to a threshold of 2° and issuing a warning if this threshold is exceeded.

Advantageously, the selection step involves selecting a plurality of vehicles of the same model, and the steps of inclining the vehicles and of recording the projection of gravity in the intrinsic reference frame are carried out on each of the vehicles of said plurality of vehicles. Calibrating on a plurality of vehicles thus prevents problems relating to a single selected vehicle, such as installation error or degradation of the inclination sensor, from distorting the calibration and thus all the inclination angle measurements of any vehicles that are subsequently calibrated.

Also advantageously, the step of computing a projection matrix comprises a sub-step of computing the average of the plurality of projections of the earth's gravity over the three axes of the intrinsic reference frame for each of the vehicles of said plurality of vehicles. The projection matrix is thus computed on average values that take into account slight differences in the values measured by the various inclination sensors.

Preferably, in this embodiment, the step of computing the average is followed by a sub-step of computing the standard deviation relative to the average computed for each of the selected vehicles, and the step of computing the projection matrix is carried out based on the average of the measured projections corresponding to the vehicles having a standard deviation that is less than a predetermined value. It is thus possible to identify, from among the selected vehicles, those vehicles whose inclination sensor measurements are outside a confidence interval, thus indicating a problem and that the one or more relevant vehicles should not be taken into account when computing the projection matrix due to the risk of introducing errors into the calibration.

According to another aspect, the invention also relates to a computer program product, characterized in that it comprises a set of program code instructions which, when they are executed by one or more processors, configure the one or more processors to implement a method as described above.

According to another aspect, the invention also relates to a calibration device for calibrating the measurement of an inclination angle of at least one motorized two-wheeled vehicle, said vehicle comprising an electronic control unit, said electronic control unit comprising an inclination sensor and a memory zone, said inclination sensor being configured to determine the projection of the earth's gravity over three axes of an intrinsic reference frame of the inclination sensor, the electronic control unit being configured to compute the inclination angle based on the projection of the earth's gravity over the three axes of a reference frame specific to the vehicle, said calibration device being configured:
to be connected to the electronic control unit via an electronic communication link;
to record the value of the projection of the earth's gravity over the three axes of an intrinsic reference frame of the inclination sensor when the vehicle is inclined at a predetermined lateral inclination angle;
to compute a projection matrix between the intrinsic reference frame of the inclination sensor and the reference frame specific to the vehicle based on the projection of the earth's gravity over the three axes of the intrinsic reference frame and the reference frame of the vehicle.

The calibration device allows the projection matrix to be computed, which is then recorded in the electronic control units so as to ensure that the calibration for each vehicle corresponds to the selected vehicle model.

### BRIEF DESCRIPTION OF THE DRAWINGS

Further features and advantages of aspects of the invention will become more clearly apparent upon reading the following description. This description is purely illustrative and should be read with reference to the appended drawings, in which:

FIG. 1 schematically illustrates a motorized two-wheeled vehicle in which the method according to an aspect of the invention is applied;

FIG. 2 schematically illustrates the vehicle inclined at the two inclination angles during the process according to an aspect of the invention;

FIG. 3 schematically illustrates an electronic control unit of the calibrated vehicle;

FIG. 4 schematically illustrates the determination of the reference frame of the vehicle based on the vectors of the earth's gravity measured in the two inclinations of the vehicle;

FIG. 5 schematically illustrates the sequence for the method according to an aspect of the invention.

### DETAILED DESCRIPTION OF EXEMPLARY EMBODIMENTS

The calibration method according to an aspect of the invention is applied to a motorized two-wheeled vehicle 1 via a calibration device 2.

### Vehicle 1

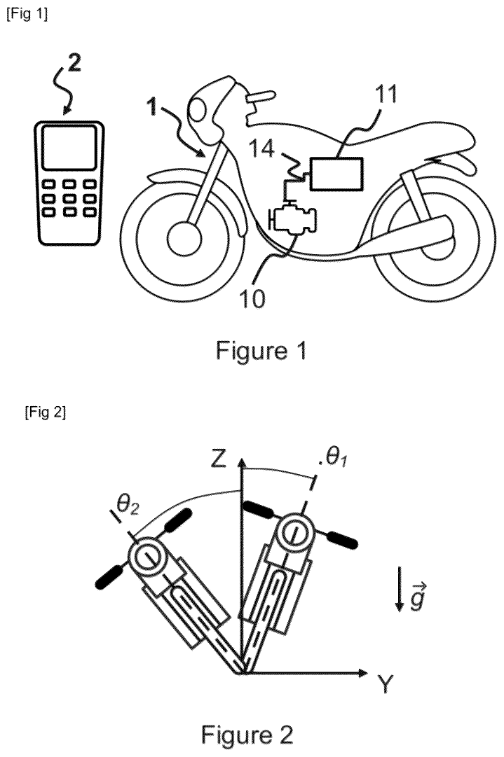

As shown in FIG. 1, the vehicle 1 comprises an engine 10, an electronic control unit 11, and a communication link 14.

When calibrating the vehicle 1, the vehicle 1 is held at a predefined inclination by a holding device, which is not shown in the figures for the sake of clarity.

As shown in FIG. 2, the vehicle 1 is inclined at a first inclination 01 and then at a second inclination 02.

A reference frame specific to the vehicle 1 needs to be defined that the inclination angle of the vehicle 1 is measured against.

For a plurality of vehicles 1 from the same series, the electronic control unit 11 is identical and is positioned at the same location in the vehicle 1, and at the same inclination.

### Engine 10

The engine 10 allows the torque to be produced that is required to drive the wheels of the vehicle 1 when the vehicle 1 is moving.

The engine 10 is not running during the calibration method.

### Electronic Control Unit 11

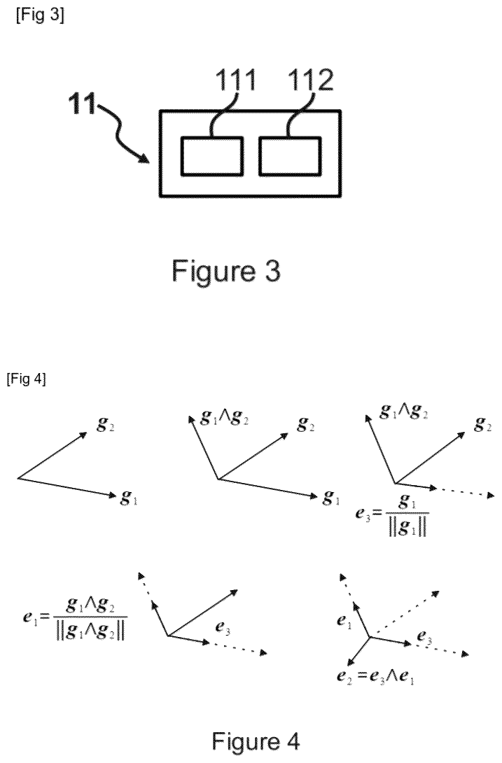

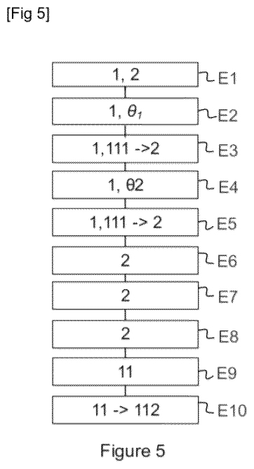

As shown in FIG. 3, the electronic control unit 11 comprises an inclination sensor 111 and a memory zone 112.

The inclination sensor 111 is preferably a MEMS type accelerometer, configured to compute the projection of the earth's gravity over three axes of a reference frame.

The reference frame of the inclination sensor is an intrinsic reference frame, i.e., it solely depends on the arrangement of the components inside the inclination sensor 111.

The electronic control unit 11 is configured to compute the lateral inclination angle of the vehicle 1 relative to the earth's vertical Z based on the three projections measured by the inclination sensor 111.

Mathematically, in order to obtain the angle measurement, a projection matrix needs to be applied to the measurements of the inclination sensor 111, which measurements are related to the intrinsic reference frame, in order to adapt them to the reference frame of the vehicle 1 and allow the inclination angle to be computed.

The memory zone 112 is configured to record information. In particular, the memory zone 112 is configured to store the projection matrix computed during the method according to an aspect of the invention.

The electronic control unit 11 is configured to compare the computed inclination angle with an inclination threshold.

The inclination threshold corresponds to the angle from which the electronic control unit 11 considers the vehicle 1 to be falling.

The electronic control unit 11 is configured to implement a function to stop the engine 10 of the vehicle 1 if the measured lateral inclination angle is greater than the inclination threshold.

The electronic control unit 11 is configured to compute the rotation matrix based on the measurements of the inclination sensor 111 during the calibration method and to define an orthonormal reference frame for measuring the inclination angle of the vehicle 1.

### Communication Link 14

The communication link 14 allows communication between the electronic control unit 11, the engine 10 and the communication device 2.

Preferably, the communication link 14 is a wired communication link.

### Calibration Device 2

The calibration device 2 is a computer device that is connected to the vehicle 1, preferably in such a way that it is connected to the electronic control unit 11.

Preferably, the calibration device 2 is a computer equipped with software for receiving the measurements of the projections of the earth's gravity taken by the inclination sensor 111 in the reference frame of said inclination sensor 111, for processing this data using a spreadsheet and for storing the data.

When the method is applied to a plurality of vehicles 1, the calibration device 2 is configured to compute an average and a standard deviation of the measurements of the projections of the earth's gravity from the plurality of vehicles 1.

Preferably, the calibration device 2 is configured to identify the measurements associated with a standard deviation above a predetermined threshold, so that they are not taken into account when computing an average that is used to determine the projection matrix.

### Embodiment

During the calibration method according to an aspect of the invention, multiple vehicles 1 are selected in a first step E1.

Each selected vehicle 1 is installed in a calibration stand that allows the vehicle 1 to be inclined at a controlled incline.

In another operating mode, the vehicle 1 is installed on an adjustable stand that allows the inclination angle of the vehicle to be varied when it is deployed. In this case, it is important that the uniformity and the inclination of the ground are checked in advance so as not to distort the calibration. Ideally, the inclination of the ground should be less than 2°.

In a second step E2, each vehicle 1 is inclined at a first predetermined inclination angle.

In a step E3, the calibration device 2 connected to the inclined vehicle 1 records the values of the projections of the earth's gravity measured by the inclination sensor 111 in the intrinsic reference frame of said inclination sensor 111.

In a step E4, each vehicle 1 is inclined at the second reference inclination angle.

In a step E5, the calibration device 2 connected to the vehicle 1, inclined at the second inclination angle, records the values of the projections of the earth's gravity measured by the inclination sensor 111 in the intrinsic reference frame of said inclination sensor 111.

In a step E6, the calibration device 2 computes an average and a standard deviation for each of the three projections of gravity measured by the inclination sensor 111 for the two reference inclination angles.

In a step E7, the calibration device 2 compares the standard deviations for each vehicle 1 with a predetermined threshold. If a standard deviation is greater than the threshold, the calibration device 2 excludes the data originating from the relevant vehicle 1.

An excessive standard deviation can indicate a fault in the installation or the operation of the electronic control unit 11 on the relevant vehicle 1. Basing the calibration on this vehicle 1 could then distort it and thus cause errors in the computations of the inclination angle on all the vehicles 1 in the corresponding series.

In a step E8, the calibration device 2 computes an average value of each projection for the two reference inclination angles, by only taking into account the values retained in step E7.

In a step E9, the electronic control unit 11 receives the two vectors corresponding to the average values computed in step E8 and determines the orthonormal reference frame of the vehicle 1 and the projection matrix between the intrinsic reference frame of the inclination sensor 111 and this reference frame of the vehicle 1.

As shown in FIG. 4, this step begins by computing the vector product between the two vectors g1 and g2 corresponding to the earth's gravity measured in the intrinsic reference frame of the inclination sensor 111 for the two inclination angles. The resulting vector g1\hat{ }g2 is perpendicular to the first two vectors g1 and g2.

Next, a vector e3 is computed by normalizing the first vector of the earth's gravity g1, i.e., by dividing it by its length in order to obtain a unit vector with a norm equal to unity.

The same operation is carried out on the vector g1\hat{ }g2 resulting from the vector product in order to obtain a unit vector e1.

Finally, a third vector e2 is computed by the vector product between the vector e3 and the vector e1. Due to the mathematical properties of the vector product, this vector itself has a norm equal to unity and perpendicular to the two vectors e1 and e3.

The reference frame formed by the vectors e1, e2, e3 is therefore an orthonormal reference frame, and the projection matrix for transitioning from the intrinsic reference frame of the inclination sensor 111 to this reference frame is the 3×3 square matrix whose columns correspond to the vectors e1, e2 and e3.

Once the projection matrix has been computed, it can be stored, in a subsequent step E10, in the memory zone 112 of each electronic control unit 11 mounted on a vehicle 1 of the series corresponding to the selected vehicles 1.

This projection matrix allows each electronic control unit 11 to quickly and efficiently convert the values measured by the inclination sensor 111 in order to be able to compute the lateral inclination angle relative to the reference frame of the vehicle 1, without having to calibrate each vehicle 1 individually.

1. A method for calibrating an inclination sensor intended to be mounted on a motorized two-wheeled vehicle said vehicle comprising an electronic control unit, said electronic control unit comprising said inclination sensor and a memory zone said inclination sensor being configured to determine the projection of the earth's gravity over three axes of an intrinsic reference frame of the inclination sensor the electronic control unit being configured to compute the inclination angle based on the projection of the earth's gravity over the three axes of a reference frame specific to the vehicle said method being partially implemented by a calibration device connected to the vehicle and comprising:
selecting at least one two-wheeled vehicle comprising said inclination sensor to be calibrated;
inclining the at least one selected vehicle at a first determined lateral inclination angle;
recording, by the calibration device the value of the projection of the earth's gravity over the three axes of the intrinsic reference frame of the inclination sensor when the at least one vehicle is inclined at the first lateral inclination angle;
inclining the at least one selected vehicle at a second predetermined lateral inclination angle;
recording, by the calibration device the value of the projection of the earth's gravity over the three axes of the intrinsic reference frame of the inclination sensor when the at least one vehicle is inclined at the second lateral inclination angle;
computing, by the electronic control unit, a projection matrix between the intrinsic reference frame of the inclination sensor and the reference frame specific to the vehicle based on the projection of the earth's gravity over the three axes of the intrinsic reference frame and the reference frame of the vehicle and
recording the computed projection matrix in the memory zone of the electronic control unit for each vehicle corresponding to the type of vehicle comprising said electronic control unit.

2. The method as claimed in claim 1, wherein the step of computing the projection matrix between the intrinsic reference frame of the inclination sensor and the reference frame specific to the vehicle is carried out by computing the vector product between the vector of the earth's gravity in the first inclination and the vector of the earth's gravity in the second inclination by normalizing the vector of the earth's gravity in the first inclination, by normalizing the vector computed by the vector product, and by computing a third vector based on the vector product of the two normalized vectors and by computing the projection matrix whose columns are the three vectors thus normalized.

3. The method as claimed in claim 1, wherein the difference between the first inclination angle and the second inclination angle is greater than 15 degrees.

4. The method as claimed in claim 1, comprising a preliminary step of checking physical parameters required for the calibration.

5. The method as claimed in claim 4, wherein the preliminary step of checking physical parameters includes measuring the inclination of the ground.

6. The method as claimed in claim 1, wherein the selection step involves selecting a plurality of vehicles of the same model, and the steps of inclining the vehicles and of recording the projection of gravity in the intrinsic reference frame are carried out on each of the vehicles of said plurality of vehicles

7. The method as claimed in claim 6, wherein the step of computing a projection matrix comprises a sub-step of computing the average of the plurality of projections of the earth's gravity over the three axes of the intrinsic reference frame for each of the vehicles of said plurality of vehicles

8. The method as claimed in claim 7, wherein the step of computing the average is followed by a sub-step of computing the standard deviation relative to the average computed for each of the selected vehicles and the step of computing the projection matrix is carried out based on the average of the measured projections corresponding to the vehicles having a standard deviation that is less than a predetermined value.

9. A non-transitory computer program product, comprising a set of program code instructions, which, when they are executed by one or more processors, configure the one or more processors to implement a method as claimed in claim 1.

10. A calibration device for calibrating the measurement of an inclination angle of at least one motorized two-wheeled vehicle said vehicle comprising an electronic control unit said electronic control unit comprising said inclination sensor and a memory zone said inclination sensor being configured to determine the projection of the earth's gravity over three axes of an intrinsic reference frame of the inclination sensor, the electronic control unit being configured to compute the inclination angle based on the projection of the earth's gravity over the three axes of a reference frame specific to the vehicle said calibration device being configured:
to be connected to the electronic control unit via an electronic communication link;
to compute the projection of the earth's gravity over the three axes of a reference frame of the vehicle when the vehicle is inclined at a lateral inclination angle;
to record the value of the projection of the earth's gravity over the three axes of an intrinsic reference frame of the inclination sensor when the vehicle is inclined at a predetermined lateral inclination angle;
to compute a projection matrix between the intrinsic reference frame of the inclination sensor and the reference frame specific to the vehicle based on the projection of the earth's gravity over the three axes of the intrinsic reference frame and the reference frame of the vehicle.
